(19) United States
(12) Patent Application Publication
(10) Pub. No.: US 2012/0285052 A1
(43) Pub. Date: Nov. 15, 2012

(54) GROMMETLESS MULTI-LAYERED INDUSTRIAL ID TAG

(76) Inventors: Kenneth D. Baker, Overland Park, KS (US); Dianna J. Maxwell, Overland Park, KS (US)

(21) Appl. No.: 13/471,278

(22) Filed: May 14, 2012

Related U.S. Application Data
(60) Provisional application No. 61/486,185, filed on May 13, 2011.

(51) Int. Cl. G09F 3/02

(52) U.S. Cl. 40/27; 40/675

(57) ABSTRACT

The present invention is directed to a grommetless multi-layered industrial identification tag secured to equipment whereby the tag conveys data associated with the securing equipment, the tag including a laminate assembly including a raised data field; an assembly bed supporting said laminate assembly; a peripheral disc in communication with said assembly bed and encircling said laminate assembly; a conduit section extending through said assembly bed and presenting a grommetless entry portal, said conduit section being adapted for receipt of an anchor therethrough for securing said tag to the equipment; and said raised data field having a plurality of data identifiers providing operational data about the equipment.

### CROSS REFERENCE TO RELATED APPLICATION

This application claims priority under 35 U.S.C. 119(e) and 37 C.F.R. 1.78(a)(4) based upon copending U.S. Provisional Application Ser. No. 61/486,185 for MULTI-COLORED MULTI-LAYERED INDUSTRIAL VALVE AND EQUIPMENT TAG, filed May 13, 2011, the disclosure of which is incorporated herein by reference.

### FIELD OF THE INVENTION

The present invention relates to field identification tags and more particularly to a grommet-less multi layered identification tag which includes multiple color layers for identification of industrial, commercial and agricultural equipment and systems.

### BACKGROUND OF THE INVENTION

Various industries uses ID-tags or labels in a variety of situations to instruct personnel that a potentially dangerous situation exists or to provide information about various equipment or industrial processes. For example, when a piece of equipment or a transmission line is disabled so that it can be serviced, the service person attaches a lock or tag to the switch while he is servicing the line or equipment, often at a remote location not visible from the switch. The workers will not accidently re-energize the equipment while the lock or tag is present.

The use of such tags is mandated not only by common sense, but in some instances government regulations require their use. Some methods of providing an identification tag include embossing, screening or engraving indicia on a plastic body. This may be accomplished with paint or other coating to achieve the desired indicia. While this may work temporarily, over time and with constant exposure to the ambient weather, the paint or other indicia will wear off or the tag will break.

Other attempts to provide an identification tag include providing a multi-layered tag with various layers of flexible plastic material to create various indicia, including visually contrasting indicia. However, again over time and in response to ambient conditions these tags may delaminate and fall apart.

Die stamped tags have also been used in which the indicia is stamped or lasered into the material of the tag body, leaving either a recessed area or an opening through the tag thickness in the shape of the indicia. This type of tag is time consuming and expensive to make and, over time, the recesses or openings become filled with dirt or debris causing the tag to be illegible in some cases.

A suitable ID-tag should be constructed from materials which are resistant to severe environmental conditions and non-hazardous. The design of the tag should be such that the information printed on it is readily observed, recognized and visible from a distance and generally protected from the environment, under adverse lighting, ambient and inclement weather conditions, as well as being tamper-resistant for use for an extended period of time.

In addition, they should provide a variety of critical information and greater recognition qualities to personnel thru the use of multiple types of color coded graphics and standardized data field placement. For example, some industry practices involve the labeling of pipes and other process transmission equipment in an ammonia refrigeration facility, it may require an excessive number of existing tags to obtain enough information to decipher the process characteristics which service personnel may need to understand the current process. In some cases, the omission of just one tag may critically change the interpretation of the present process like the pressure, fluid origination or destination, fluid flow or fluid state.

Tags maybe affixed to or hung from the equipment they identify with a mechanical fastener such as a chain, cable or wire which is inserted through the tag, at a grommet or may be affixed with adhesive compounds or adhesive tapes, pressure sensitive foams or various types of fixed mechanical fasteners such as rivets, screws or bolts. When hung from the equipment using chains, cable or wire fasteners, the tag may fail with the reciprocal movement of the tag upon this hanger, which over time may completely bisect the tag causing it to become detached from the equipment it is intended to identify, rendering the tag useless. To overcome these issues, some manufactures have utilized a grommet to reinforce the tag. However, these grommets or eyelets, while providing an initial degree of protection only offer limited protection in that within a short amount of time, with wind or other oscillating forces, they may become worn through or become dislodged from the tag they are intended to protect.

Additionally, warning tags which use grommets or eyelets may cause equipment failure. Some of the eyelets or grommets are made from brass or stainless steel grommets. Metal grommets have the disadvantage that they can rust and even more importantly, they are electrically conductive. When warning tags with grommets are used in areas with lighting, electricity, power lines or electric fields the grommets or id tags having grommets may fail causing electrical communication between the failed grommet and the surrounding equipment causing arcing or flashing which can led to damage or injury to the associated equipment or personnel.

U.S. Pat. No. 4,407,524 (Trautlein) discloses a durable ID-tag having a durable backing member and an adhesive clear cover member. U.S. Pat. No. 5,411,784 (Brewster) discloses a self-laminating polyester tag having a pressure sensitive layer with a grommet. Neither of these disclose the present invention for which a need exists for a grommet-less, multi-colored, multi-layered ID tag which provides an equipment tag with a raised data field with digitally created and thermally printed textual and graphical information contained within a plurality of fields which includes a thermally and environmentally protected layered surface with a rigid assembly bed supporting a laminate assembly for use in harsh, indoor and outdoor conditions.

### SUMMARY OF THE INVENTION

The present invention is directed to a grommetless multi-layered industrial identification tag secured to equipment whereby the tag conveys data associated with the securing equipment, the tag including a laminate assembly including a raised data field; an assembly bed supporting said laminate assembly; a peripheral disc in communication with said assembly bed and encircling said laminate assembly; a conduit section extending through said assembly bed and presenting a grommetless entry portal, said conduit section being adapted for receipt of an anchor therethrough for securing said tag to the equipment; and said raised data field having a plurality of data identifiers providing operational data about the equipment.

### BRIEF DESCRIPTION OF THE DRAWINGS

FIG. 1 is a plan view of an exemplary embodiment of a grommet-less multi-layered industrial identification tag in accordance with the present invention.

FIG. 2 is a side elevation view in accordance with the embodiment of FIG. 1.

FIG. 3 is a bottom plan view in accordance with the embodiment of FIG. 1.

FIG. 4 is a plan view of the raised data field in accordance with the embodiment of FIG. 1.

FIG. 5 is a partial cross-sectional plan view in accordance with the embodiment of FIG. 1.

FIG. 6 is a side elevation in accordance with the embodiment of FIG. 1.

FIG. 7 is an alternative embodiment of the grommet-less, multi-layered industrial identification tag.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, (but merely as a basis for the claims) and as a representative basis for teaching one skilled in the art to variously employ the present invention in virtually any appropriately detailed structure.

FIG. 1 illustrates an exemplary embodiment of the present invention having a preprinted, multi-colored (not shown) multi-layered identification tag illustrating various fields to inform service, maintenance, safety and inspection personnel regarding process equipment such as, but not limited to, valves, pipes and equipment. For example, the tag may include information related to the pressure, direction of flow, installation and service dates and other desired information related to the process or tagged equipment.

Consistent with the exemplary embodiment of FIG. 1, one side of the rigid tag 10 includes a laminate assembly 120 with a raised data field 102 supported by an assembly bed 101, a peripheral disc 110 encircling the laminate assembly 120 and a conduit section 109 extending through the raised data field 102 associated with the laminate assembly 120 and adapted for receipt of an anchor 112 therethrough for positioning the rigid tag 10 on the associated equipment. In FIG. 1, the peripheral disc 110 can be seen extending along an upper pair of convex curved corners followed by a lower pair of concave curved corners which encircle the raised data field 102.

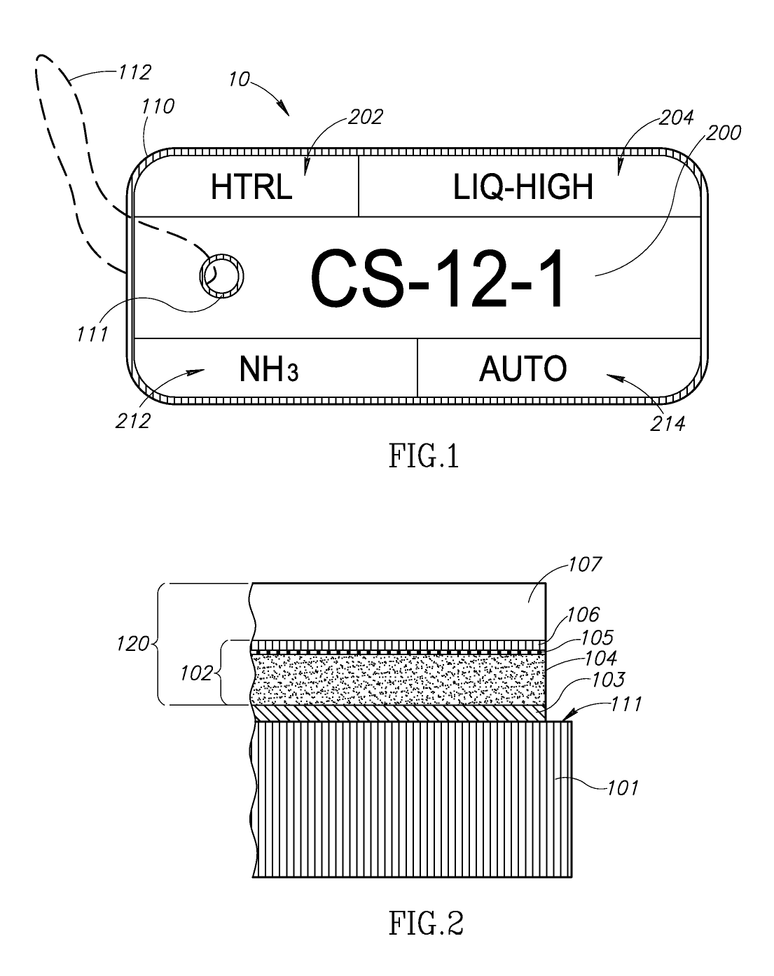

As illustrated in FIG. 2, the laminate assembly is secured to the assembly bed 101 with a sealant 103. In addition, as further indicated by FIG. 2, the laminate assembly 120 further includes the raised data field 102 and an outer protective barrier 107. The raised data field 102 generally includes indicia 105 such as, but not limited to, the printed data identifiers 200, 202, 204, 212, 214 imprinted upon the indicia receptive surface 104. The outer protective barrier 107 at least partially protects the raised data field 102 so that the indicia 105 remains visible during operation.

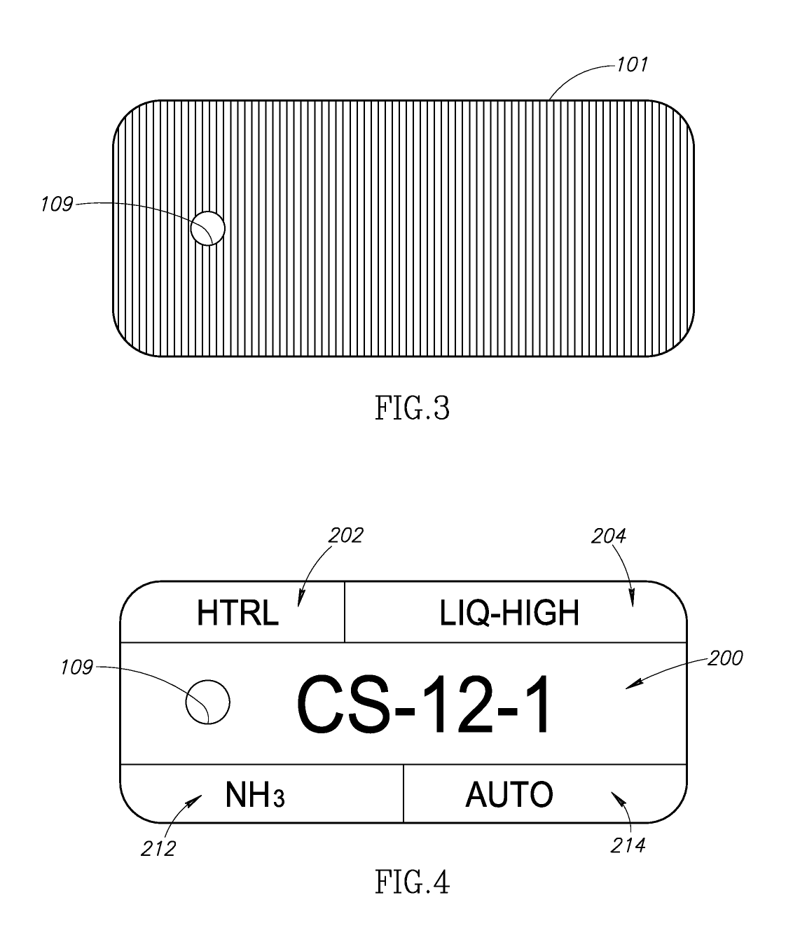

The rigid tag 10 is a generally unitarily rigid structure which includes the laminate assembly 120 and laminate assembly bed 101 for receiving and supporting the laminate assembly 120 in a substantially planar manner. In addition, the laminate assembly bed 101 has sufficient thickness to support and withstand anticipated ambient conditions. FIG. 3. illustrates the bottom surface of the assembly bed 101.

Generally, the assembly bed 101 is durable and provides sufficient protection to resist UV radiation and common industrial chemicals. The assembly bed 101 may be configured into almost any shape for the identification tag 10, including circular, rectangular or multiple sided shapes and may have a thickness ranging from 0.0299″ to 0.0478″ thick with 0.0359″ being an exemplary thickness. In addition, the assembly bed 101 may be fabricated from either 316 or 304 grade stainless steel, although it is not limited thereto as other grades and thicknesses may be desired. The assembly bed 101 may also be fabricated using laser or die-cut manufacturing methods depending on the desired production characteristics, while providing flexibility for the dimension and shape of the assembly bed 101.

The tag 10 may be mechanically fastened to the desired equipment such as, but not limited to a pipe, valve or other industrial or process equipment with anchor 112 which while illustrated as a chain may alternatively be a wire, cable or other mechanical fastener which extends through a conduit section 109. Alternatively, the tag 10 may include a plurality of conduit sections (not shown) for use with multiple anchors 112.

The raised data field 102 extends interiorly from the peripheral disc 110 and vertically from the assembly bed 101 and includes the graphical portions associated with the laminated assembly 120, namely the indicia 105 and the indicia receptive surface 104 which receives and displays the received indicia 105. By way of example and not as a limitation, indicia 105 is illustrated below and in the accompanying drawings as data identifiers 200, 202, 204, 212, 214 but may also include graphics, colors and other visual elements. Generally, the raised data field 102 will have a dimension similar to the rigid base 101 less the peripheral disc 110 which extends around the perimeter of the laminated assembly 120.

As further illustrated in FIGS. 4 and 5, the raised data field 102 includes a plurality of layers associated with visual elements of the multilayered tag 10, such as the indicia receptive surface 104 and lens 106 which provides image stabilization and desired optical enhancements of the indicia 105 for use within the harsh operating environment.

The indicia receptive surface 104 may be thermally receptive to receiving the desired indicia 105 which may be organized in to a plurality of segregated sub-fields printed thereon and presenting the plurality of data identifiers 200, 202, 204, 212, 214 associated with the relevant equipment (not shown).

The data identifiers 200, 202, 204, 212, 214 are each examples of indicia 105 and may include a variety of color coded graphics and process related data generally provide operational data for operation personnel. By way of example and not as a limitation, the indicia may meet the required portions of standard process regulations such as ASTM and ANSI. As illustrated, the plurality of data identifiers 200, 202, 204, 212, 214 are readily visible at a distance to sufficiently describe the process associated with the equipment along with the equipment itself.

Indicia 105 may include the graphics, colors, symbols or other visual elements associated with the data identifiers 200, 202, 204, 212, 214. Indicia 105 may be created using a computer and digital print software and thermally printed using a thermal printer onto indicia receptive surface 104 with the indicia 105 positioned on the upper surface of the indicia receptive surface 104. The indicia 105 and the indicia receptive surface 104 are layered below the lens 106 which together with the indicia receptive surface 104 are secured to the assembly bed 101 with a sealant 103 as illustrated in FIGS. 2 and 5. Because the indicia 105 may be created using digital print software (not shown) and thermally printed using a thermal printer (not shown), the tag 10 may include a wide variety of potential colors, alpha-numerical, graphical and graphic and or non-graphic customization.

The indicia 105 may be numbers, letters, symbols or graphics and may also include a variety of fonts, styles and colors while conveying relevant data. In one embodiment, the indicia 105 uses multiple, vibrant colors, data fields and highly visible and contrasting graphics relative to background colors which are unique for the intended application and readily interpreted without unnecessary conversion of multiple tags to interpret the desired operational process. Additionally, the indicia 105 may incorporate colored fields, backgrounds or symbols to convey the desired data such as yellow for caution, red for fire protection and others.

The indicia receptive surface 104 is generally a rigid vinyl surface which offers excellent outdoor durability and superior printing and legibility characteristics while operating in a variety of environmental conditions. The indicia receptive surface 104 maintains a secure intermediate layer with the received indicia 105 and the underlying sealant 103. The indicia receptive surface 104 can be used in a planar or non-planar configuration, however, in general is planar and provides excellent surface smoothness for superior image quality.

The sealant 103 is generally a modified acrylic coating which is sensitive to receipt of the indicia receptive surface 104 for application of the laminated assembly to the 120 to the assembly bed 101. The sealant 103 generally has high adhesive properties and when applied to the assembly bed 101 coats the bed 101, securing the laminated assembly 120 at the indicia receptive surface 104 and depending on the particular sealant 103 can improve the longevity and durability of the indicia receptive surface 104. The sealant 103 can be formed and applied as a laminar sheet or applied as a liquid and sprayed onto the desired surface. In one embodiment, the sealant 103 may range, from about 1 mil to 2.1 mils thick modified acrylic adhesive.

The lens 106 is an optically transparent, high clarity coating which may be layered above the indicia receptive surface 104 in receipt of the desired indicia 105. The lens 106 adjusts the visualization of the indicia 104, in general providing improved optical clarity to the indicia 104 during use of the tag 10 in the harsh operating environment. The improved optical clarity of the lens 106 allows for easier identification and ready recognition of the contained indicia 105 by various system personnel. While different lens 106 coatings may provide different optical effects, in general the preferred lens 106 coating will have a high clarity imaging characteristics and provide image stabilization of the indicia 105. About 80 to 90% of the received light is transmitted through the lens 106. In addition, the lens 106 stabilizes the indicia 105 received by the indicia receptive surface 104 for use in an industrial environment over prolonged, substantial use.

In one embodiment, the lens 106 is an optically clear film which ranges from about 0.25 mils thick to 4 mils thick with one application being around 1 mil thick. In addition, the lens 106, may be, but is not limited to, a double-adhesive polyester film which promotes adhesion of inks and dyes. The lens 106 generally cures with exposure to UV radiation while limiting excess shrinkage and remaining adaptable for use in either an embossing or die cutting application. The lens 106 may be applied as a laminar sheet or as a liquid, but if applied as a laminar sheet it can have adhesive properties on one or both sides to facilitate layering with the underlying indicia receptive surface 104 in receipt of the desired indicia 105.

The illustrated peripheral disc 110 has a non-recessed seamless surface extending circumferentially along the upper surface of the assembly bed 101 while presenting the raised data field 102. The seamless peripheral disc 110 decreases frictional and mechanical abrasion resulting to the surface of the tag 10. By reducing the abrasion experienced by the tag 10 surface, the peripheral disc 110 also reduces any associated mechanical edge peeling, snagging or delamination of the laminated assembly 120 either within the laminated assembly 120 or to the laminated assembly 120 from the assembly bed 101. The peripheral disc 110 is also in electrical communication with the assembly bed 101 and the entry portal 111. An exemplar peripheral disc 110 may range in width from 1/16″ to 1/32″ thick.

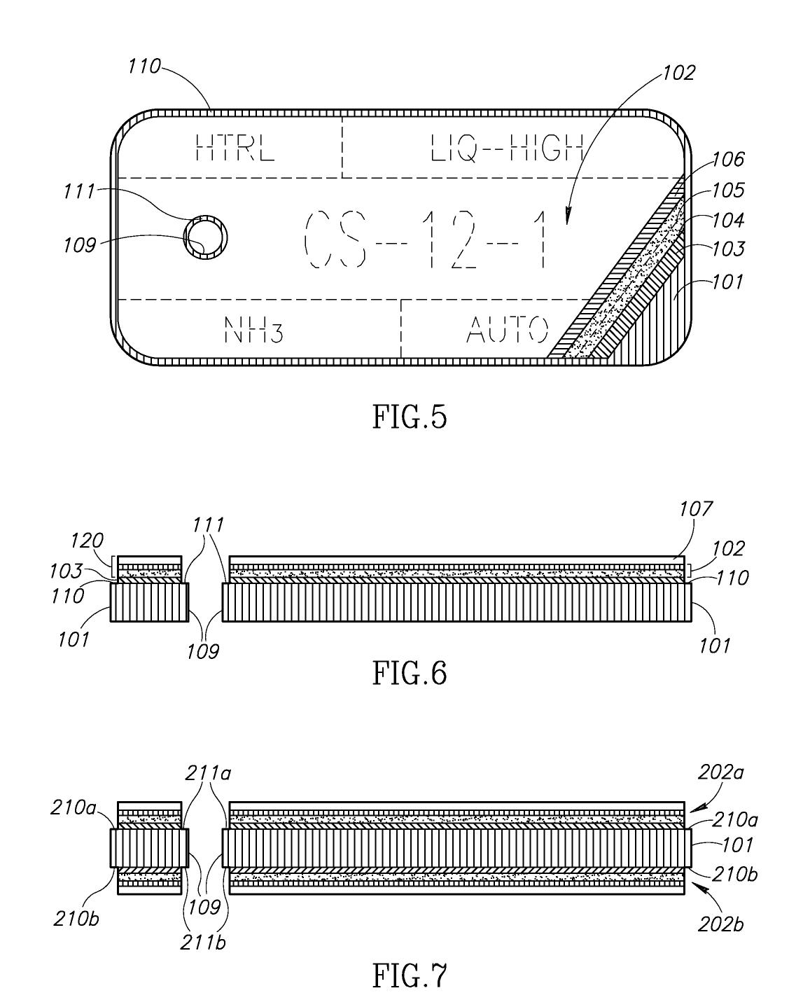

As further illustrated in FIGS. 1 and 6, a rear surface of tag 10 is in communication with the entry portal 111 through the cylindrical conduit section 109 which generally extends from the rear surface to a front surface of the tag 10. The front surface of the tag 10 is generally associated with the raised data field 102. The conduit section 109 has sufficient size and dimension for conveying the desired anchor 112 between the front to the rear of tag 10 and for securing the tag 10 onto the desired equipment (not shown). The entry portal 111 generally extends circumferentially around the conduit section 109 and is also generally associated with the front or first side of the rigid tag 10.

The outer protective barrier 107 provides a barrier from the harsh environment, protecting the integrity of and sealing the raised data field 102 and more particularly the graphic elements contained therein from the surrounding conditions. In addition, the outer protective barrier 107 provides excellent resistance to scratches and abrasion. The outer protective barrier 107 consists of a UV and abrasion resistant material such as, but not limited to, polycarbonate or polyester. In one application the outer protective barrier 107 may range from about 5 mils to about 10 mils and is generally capable of withstanding substantial sunlight exposure. The outer protective barrier 107 may be a polyester hardcoat overlaminate, however, other compositions may be used such as polycarbonate.

In the illustrated embodiment, the indicia receptive surface 104 with superimposed indicia 105 is applied to the first side of the assembly bed 101 using the sealant 103, the indicia 105 being spaced opposite the assembly bed 101. Simultaneously, the indicia receptive surface 104 is secured to the outer protective barrier 107 using the lens 106, both sides (an upper and a lower) of the indicia receptive surface 104 having adhesive properties.

In operation, the raised data field 102 provides necessary equipment and process information through the use of graphics, colors or other indicia, which are readily recognizable by system personnel and consistent with an Alert Notification System.

The Alert Notification System may include a centrally located equipment identifier 200 and a plurality of device data identifiers 202, 204 and a plurality of system data identifiers 212, 214, each of the device data identifiers 202, 204 being associated with one of the convex curved corners and each of the system data identifiers 212, 214 being associated with one of the concave curved corners, the device data identifiers 202, 204 and system data identifiers 212, 214 surrounding the equipment identifier 200 and providing relevant data to system personnel about the surrounding equipment.

The device data identifiers 202, 204 provide data specifically related to the specific equipment identified by the equipment identifier 200. The system data identifiers 212, 214 include data specifically related to the process within which the device is operated. Color coding may also be utilized either as a single colored tag or multi-colored tag with various colors utilized in a systematic manner within each data identifier field to help readily inform the operator, service, maintenance, safety and inspection personnel of the device, process or other desired parameters such as contents pressure, direction and other critical designators. In addition to colored backgrounds, the tag 10 may include a photo luminescent background color to help illuminate the tag 10 in low light conditions to help readily and quickly identify the tag 10 and the data associated with the tag 10.

In an alternative embodiment further illustrated in FIG. 7, first and second raised data fields 202a, 202b are associated with opposite sides of the assembly bed 101 wherein a first and second peripheral disc 210a, 210b each presenting a seamless surface extending circumferentially along each side and being in electrical communication with each other, the and a first and second entry portal 211a, 211b and the assembly bed 101. The first and second raised data field 202a, 202b are oppositely spaced on the assembly bed 101 with conduit 109 extending therebetween for receipt of the anchor 112.

The preferred forms of the invention described above are to be used as illustration only, and should not be utilized in a limiting sense in interpret the scope of the present invention. Obvious modifications to the exemplary embodiments, as herein set forth, could be readily made by those skilled in the art without depart from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

What is claimed and desired to be secured by Letters Patent:

1. A grommetless multi-layered industrial identification tag apparatus secured to equipment whereby said tag conveys data associated with the securing equipment, said tag comprising:
a laminate assembly including a raised data field;
an assembly bed supporting said laminate assembly which is secured to said assembly bed;
a peripheral disc in communication with said assembly bed and encircling said laminate assembly;
a conduit section extending through said assembly bed and presenting a grommetless entry portal, said conduit section being adapted for receipt of an anchor therethrough for securing said tag to the equipment; and
said raised data field having a plurality of data identifiers providing operational data about the equipment.

2. The apparatus of claim 1 wherein said peripheral disc extends along a pair of convex curved corners and a lower pair of concave curved corners encircling the raised data field.

3. The apparatus of claim 1 wherein said raised data field extends interiorly from said peripheral disc and vertically from said assembly bed.

4. The apparatus of claim 1 wherein said raised data field further comprises;
a indicia receptive surface in receipt of a plurality of indicia associated with said data identifiers; and
a lens layered above the indicia receptive surface.

5. The apparatus of claim 4 wherein said plurality of indicia includes an equipment identifier, a device data identifier and a system data identifier.

6. The apparatus of claim 4 wherein said plurality of indicia is organized in accordance with an alert notification system.

7. The apparatus of claim 6 wherein said alert notification system includes color coded data.

8. The apparatus of claim 6 wherein said alert notification system further comprises an equipment identifier, a device data identifier and a system data identifier being utilized to provide necessary data to system personnel about the equipment.

9. The apparatus of claim 4 wherein said plurality of indicia is thermally printed onto the indicia receptive surface.

10. The apparatus of claim 1 further comprising an outer protective barrier.

11. The apparatus of claim 1 wherein said peripheral disc is seamless.

12. A grommetless multi-layered industrial identification tag apparatus secured to equipment whereby said tag conveys data associated with the securing equipment, said tag comprising:
a first laminate assembly including a first raised data field;
a second laminate assembly including a second raised data field;
an assembly bed spanning said first and said second laminate assemblies and secured to said first and second raised data fields;
a first peripheral disc in communication with said assembly bed and encircling said first laminate assembly;
a second peripheral disc in communication with said assembly bed and encircling said second laminate assembly;
a conduit section extending from said first laminate assembly to said second laminate assembly through said assembly bed and presenting a first and second grommetless entry portal, said conduit section being adapted for receipt of an anchor therethrough for securing said tag to the equipment; and
said first and second raised data field having a plurality of data identifiers providing operational data about the equipment.
